(19) United States
(12) Patent Application Publication
(10) Pub. No.: US 2026/0319838 A1
(43) Pub. Date: Oct. 15, 2026

(54) METHOD AND SERVER FOR HANDLING MULTIPLE USER REQUESTS FOR LLM

(71) Applicant: SAMSUNG ELECTRONICS CO., LTD., Suwon-si (KR)

(72) Inventors: Wooyeon LEE, Suwon-si (KR); Youri JEONG, Suwon-si (KR); Taegeon UM, Suwon-si (KR); Jeongho SHIN, Suwon-si (KR)

(73) Assignee: SAMSUNG ELECTRONICS CO., LTD., Suwon-si (KR)

(21) Appl. No.: 19/662,474

(22) Filed: Apr. 29, 2026

Related U.S. Application Data
(63) Continuation of application No. PCT/KR2026/095576, filed on Apr. 6, 2026.

(30) Foreign Application Priority Data
Apr. 10, 2025 (KR) 10-2025-0046982
Aug. 21, 2025 (KR) 10-2025-0116817

(51) Int. Cl. G06F 9/48

(52) U.S. Cl. CPC G06F 9/4881

(57) ABSTRACT

Provided is a scheduling algorithm for handling multiple user requests for a large language model (LLM). The swap cost-aware scheduling algorithm performs operations at each scheduling time stage, the operations including: based on a swap-in cost of each of swapped requests, determining a request to be swapped in, determining a number of first blocks corresponding to requests being executed and the request to be swapped in, determining a swap-out cost of each of the requests being executed when a number of second blocks is less than the number of the first blocks, wherein the second blocks are available blocks, determining a request to be swapped out from among the requests being executed, based on the swap-out cost, switching contexts by performing swap-in and swap-out, and generating the tokens that constitute the response to each request through the decoding operation.

### CROSS-REFERENCE TO RELATED APPLICATIONS

This application is a bypass continuation application of International Patent Application No. PCT/KR2026/095576, filed on Apr. 6, 2026, which claims priority to and is based on Korean Patent Application No. 10-2025-0046982, filed on Apr. 10, 2026, and Korean Patent Application No. 10-2025-0116817, filed on Apr. 21, 2025, the disclosures of which are incorporated herein in their entireties by reference.

### BACKGROUND

### 1. Field

The disclosure relates to a scheduling algorithm to optimize memory usage and a method of handling multiple user requests for a large language model (LLM) by using the scheduling algorithm. And, the disclosure relates to a server for performing the method.

### 2. Description of Related Art

High throughput and low latency may be key metrics for measuring the performance of large language models (LLMs) deployed in an computing environment. However, it might be difficult to meet both as memory of the graphics processing unit (GPU) used to run the LLM is limited. Requests can be rescheduled but this may cause latency. Techniques to schedule requests for the LLMs can be improved to optimize memory usage while alleviating the tradeoff between throughput and latency.

### SUMMARY

According to an aspect of the disclosure, a method by which a server handles multiple user requests for a large language model (LLM) is provided. The method may include receiving a plurality of requests, and generating a response to each of the plurality of requests by handling the plurality of requests by performing swap cost-aware scheduling.

The generating of the response to each of the plurality of requests may include generating tokens that constitute the response to each of the plurality of requests through a decoding operation managed by a scheduler.

The performing of the swap cost-aware scheduling may include, based on a swap-in cost of each of swapped requests, determining a request to be swapped in, determining a number of first blocks corresponding to requests being executed and the request to be swapped in, determining a swap-out cost of each of the requests being executed when a number of second blocks is less than the number of the first blocks, wherein the second blocks are available blocks, determining a request to be swapped out from among the requests being executed, based on the swap-out cost, switching contexts by performing swap-in and swap-out, and generating the tokens that constitute the response to each request through the decoding operation.

According to an aspect of the disclosure, a server for handling multiple user requests for an LLM is provided. The server may include at least one accelerator, at least one processor, a communication interface and memory storing instructions.

The instructions, when executed by the at least one processor, cause the server to receive a plurality of requests through the communication interface, and generate a response to each of the plurality of requests by handling the plurality of requests by performing swap cost-aware scheduling.

The instructions, when executed by the at least one processor, cause the server to generate tokens that constitute the response to each of the plurality of requests through a decoding operation managed by a scheduler.

The instructions, when executed by the at least one processor, cause the server to determine a request to be swapped in based on a swap-in cost of each of swapped requests by using the swap cost-aware scheduling, determine a number of first blocks corresponding to requests being executed and the request to be swapped in, determine a swap-out cost of each of the requests being executed when a number of second blocks is less than the number of the first blocks, wherein the second blocks are available blocks, determine a request to be swapped out from among the requests being executed based on the swap-out cost, switch contexts by performing swap-in and swap-out of data between the accelerator and the processor, and generate the tokens that constitute the response to each request through the decoding operation.

### BRIEF DESCRIPTION OF DRAWINGS

The above and other aspects, features, and advantages of one or more embodiments of the present disclosure will be more apparent from the following description taken in conjunction with the accompanying drawings;

FIG. 1 illustrates a server handling multiple user requests for a large language model (LLM), according to one or more embodiments of the disclosure;

FIG. 2 is a block diagram illustrating a configuration of a server, according to one or more embodiments of the present disclosure;

FIG. 3 is a flowchart for describing operations of a server for handling multiple user requests, according to one or more embodiments of the present disclosure;

FIG. 4 is a flowchart for describing operations of a scheduling algorithm according to which a server handles multiple user requests, according to one or more embodiments of the present disclosure.

FIG. 5 is a diagram for describing a state for each request managed by a scheduling algorithm, according to one or more embodiments of the present disclosure;

FIG. 6 illustrates the overview of how a server handles multiple user requests, according to one or more embodiments of the present disclosure;

FIG. 7 is a diagram for describing operations of a server for calculating swap-out costs and determining a request to be swapped out, according to one or more embodiments of the present disclosure;

FIG. 8 is a diagram for describing operations of a server for calculating swap-in costs and determining a request to be swapped in, according to one or more embodiments of the present disclosure;

FIG. 9 is a diagram for describing operations of a server for performing cost-aware scheduling, according to one or more embodiments of the present disclosure;

FIG. 10 is a diagram for describing operations of a server for performing fine-grained swap-out, according to one or more embodiments of the present disclosure;

FIG. 11 is a diagram for describing operations of a server for performing asynchronous context switching, according to one or more embodiments of the present disclosure;

FIG. 12 is a diagram for describing operations of a server for performing a partial prefill scheduling, according to one or more embodiments of the present disclosure;

FIG. 13 is a flowchart for describing overall operations of a cost-aware scheduling algorithm according to which a server handles multiple user requests, according to one or more embodiments of the present disclosure; and

FIG. 14 illustrates a cost-aware scheduling algorithm, according to one or more embodiments of the present disclosure.

### DETAILED DESCRIPTION

Terms as used herein will be described before detailed description of embodiments of the disclosure. Throughout the disclosure, the expression “at least one of a, b or c” indicates only a, only b, only c, both a and b, both a and c, both b and c, or all of a, b, and c.

The terms as herein used are selected as common terms widely used now, taking into account principles of the disclosure, which may however depend on intentions of those of ordinary skill in the art, judicial precedents, emergence of new technologies, and the like. Some terms as herein used are selected at the applicant's discretion, in which case, the terms will be explained later in detail in connection with embodiments of the disclosure. Therefore, the terms should be defined based on their meanings and descriptions throughout the disclosure.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context. All terms including technical and scientific terms used herein have the same meaning as commonly understood by one of ordinary skill in the art to which this disclosure belongs. Terms including ordinal numbers like ‘first’, ‘second’, etc., may be used to indicate various components, but the components should not be restricted by the terms. These terms are used to distinguish one element from another.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Unless explicitly described or implicitly understood from one or more embodiments of the present disclosure, at least one of the components, elements, modules, units, or nominalized verbs represented by a block or equivalent indication in the drawings may be implemented or embodied by analog and/or digital circuits. These circuits may include one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium and execute it, with or without using one or more other components under the control of the at least one processor. This allows the at least one processor to perform at least one function or operation described above as being performed by each of the components according to the at least one instruction invoked. The at least one processor may include a central processing unit (CPU), a graphics processing unit (GPU), or another type of microprocessor, without limitation. In other examples, the at least one processor may be implemented as an application-specific integrated circuit (ASIC) or field-programmable gate array (FPGA).

Embodiments of the present disclosure will now be described in detail with reference to accompanying drawings to be readily practiced by those of ordinary skill in the art. However, the embodiments of the disclosure may be implemented in many different forms, and not limited thereto. In the drawings, unnecessary components or parts unrelated with the disclosure are omitted for clarity of the disclosure. Furthermore, throughout the specification, different reference numbers are assigned to the same component for convenience of explanation.

Further, unless stated otherwise or otherwise clear from context, phrase “based on” may refer to “based at least in part on” and not “based solely on.”

The disclosure will now be described with reference to accompanying drawings.

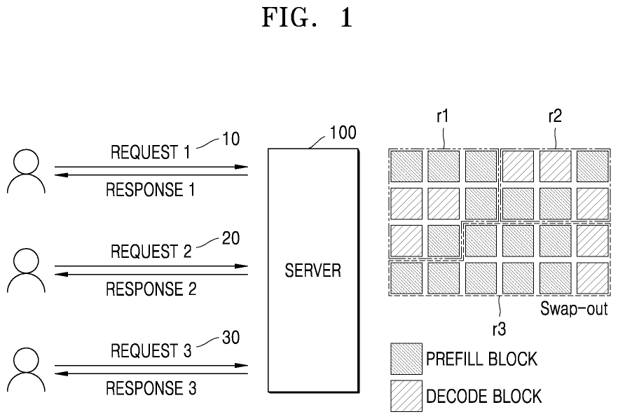

FIG. 1 illustrates a server handling multiple user requests for a large language model (LLM), according to one or more embodiments of the present disclosure.

In an embodiment, a server 100 may provide a service while operating the LLM. The server 100 may simultaneously receive requests from multiple users, and generate and provide a response to each request. For example, the server 100 may receive and handle request 1 10 from a first user and provide response 1, receive and handle request 2 20 from a second user and provide response 2, and receive and process request 3 30 from a third user and provide response 3. The request may include user requests. Simultaneously may refer to two or more events, actions, or processes occurring at the same time, substantially at the same time, or within a sufficiently short time interval such that the events are perceived or functionally treated as occurring together.

A request input to the server 100 that operates the LLM may be a prompt input by a user. The prompt is natural language text to be processed by the LLM to generate a response, and is tokenized and input to the model. One request may correspond to one response. However, there can be other variations (e.g., multiple requests corresponding to one response, multiple requests corresponding to multiple responses, one request corresponding to multiple responses).

The server 100 may perform inference of the LLM by using a high-performance accelerator (e.g., a graphics processing unit (GPU)) and use a scheduling algorithm to process the multiple requests in limited computing resources (e.g., GPU memory, computation capability, etc.).

Upon receiving an input request, the server 100 may perform a prefill operation on the input request. Prefill may refer to a process of generating a key/value (KV) cache for the entire input request in a single operation, and corresponds to a preparative operation for producing tokens that constitute a response of the LLM. The prefill result may be stored in memory of the accelerator, and the tokens that constitute the response to each request may be sequentially produced through a decoding operation managed by a scheduler.

The server 100 may use the scheduling algorithm to generate the tokens by efficiently using computing resources. The server 100 may determine which request to be prioritized, based on a service level objective (SLO) for latency, a load condition and a memory usage state of the server 100. When the cache memory space of the accelerator (e.g., GPU) is insufficient while the server 100 is processing the multiple requests, the server 100 may swap out data that is being processed (e.g., the KV cache) of lower-priority requests to outside (e.g., to CPU memory) and swap in data of higher-priority requests for processing. For example, the server 100 may swap out request 3 30 while handling request 1 10, request 2 20 and request 3 30. In this case, free space secured through swap-out may be used by the requests being executed (e.g., request 1 10 or request 2 20) or used by a swapped-in request (e.g., a request previously swapped in, a pending request, etc.).

The server 100 may calculate swap costs to determine swap-in/swap-out. For example, the server 100 may calculate a swap-out cost of each request being executed, based on at least one of transmission latency caused by swap-out of the request, throughput reduction caused by swap-out of the request, or future memory pressure caused by the request. For example, the server 100 may calculate a swap-in cost of each of swapped requests, based on the SLO for swap-in transmission time and latency.

In one or more embodiments, the server 100 may perform a cost-aware scheduling algorithm to schedule the requests through swap-out or swap-in based on the swap costs. In the disclosure, a KV cache set related to the request may be referred to as a context. Hence, context switching may refer to switching of the KV cache set being currently processed, by swapping out or swapping in the requests.

The server 100 may generate (e.g., sequentially generate) responses to the multiple user requests while minimizing the latency by handling the requests through cost-aware scheduling. Specific operations included in the cost-aware scheduling algorithm used by the server 100 will now be described in detail.

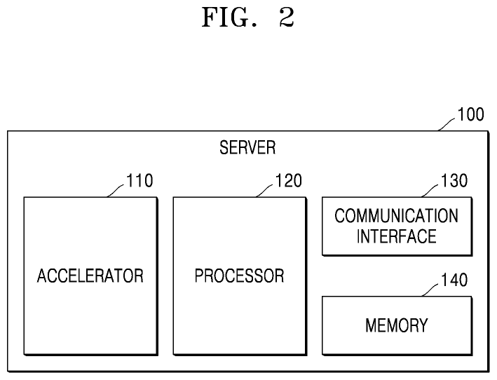

FIG. 2 is a block diagram illustrating a configuration of a server, according to an embodiment of the disclosure.

Referring to FIG. 2, the server 100 according to an embodiment may include an accelerator 110, a processor 120, a communication interface 130, and memory 140.

The accelerator 110 may process large-scale parallel operations for LLM inference or the like. There may be one or more accelerators 110. The accelerator 110 may perform large-scale prefill and decoding operations in parallel.

The accelerator 110 may include its own memory. The accelerator 110 may store the KV cache and intermediate operation data generated during the decoding process in its own memory. A scheduler may dynamically allocate and reclaim the memory of the accelerator 110.

The accelerator 110 may be, for example, a GPU, a tensor processing unit (TPU), a neural processing unit (NPU), an FPGA, an ASIC, a vision processing unit (VPU), language processing unit (LPU) etc., but is not limited thereto. The accelerator 110 may include dedicated local memory (e.g., GPU memory) configured to buffer or temporarily house data during processing, which may be subsequently transferred to memory 140.

The processor 120 may control general operations of the server 100. The processor 120 may execute one or more instructions of a program stored in the memory 140 of the server 100 to perform tasks such as controlling overall system resources, receiving and distributing requests, and executing a scheduling algorithm.

The processor 120 may handle various tasks including performing arithmetic and logical operations of processes running on the server 100, managing the main memory and transmitting data to or from the storage. The processor 120 may include a processing circuit. The processing circuit may include an operation unit that performs arithmetic and logical operations, a control unit that interprets a command and controls execution, registers that store data, and a cache memory, but is not limited thereto.

The processor 120 may include, for example, an x86 based CPU, an Advanced reduced instruction set computer (RISC) machine (ARM) based server CPU, etc., but is not limited thereto. There may be one or more processors 120. In the case that there are one or more processors 120, operations of the disclosure may be individually or collectively performed by the one or more processors.

The communication interface 130 may communicate with other electronic devices under the control of the processor 120. For example, the communication interface 130 may receive a request from a client and transmit a response to the client. The communication interface 130 may include a communication circuit that enables data communication between the server 100 and other electronic devices. The server 100 may include an interface for a network such as e.g., Ethernet, Wi-Fi, etc., for communication with the client, and may receive a user request and transmit the response through a transmission control protocol/Internet protocol (TCP/IP) based hypertext transfer protocol (HTTP) WebSocket.

The memory 140 may store data processed in the server 100.

The memory 140 may include a main memory for storing data being currently processed in the server 100. The main memory may store a program being executed by the processor 120 and data, enabling the processor 120 to quickly access the data. The main memory may include a volatile memory such as a random-access memory (RAM) or a static RAM (SRAM), but is not limited thereto.

The memory 140 may include a storage that permanently stores large-scale data (e.g., a program, an application, a system file, an LLM, etc.). The storage may include, for example, a non-volatile memory such as a hard disk drive (HDD) and a solid-state drive (SSD), but is not limited thereto.

In one or more embodiments, the server 100 may use the cost-aware scheduling algorithm to manage swap-out and swap-in. The server 100 may determine a request to be swapped out from among the requests being executed, and move a cache of the request from the accelerator 110 (e.g., GPU) to the processor 120 (e.g., CPU) or the memory 140 (swap-out). The server 100 may determine a request to be swapped in from among the swapped requests, and move a cache of the request from the processor 120 or the memory 140 to the accelerator 110 (swap-in). The swapped-out request may be swapped back into the accelerator 110 for processing in the subsequent scheduling process. In one or more embodiments, the swap-out operation of the server 100 will be described by illustrating data being moved from the memory of the accelerator 110 to the memory of the processor 120, and the swap-in operation will be described by illustrating data being moved from the memory of the processor 120 to the memory of the accelerator 110. However, it is not limited thereto.

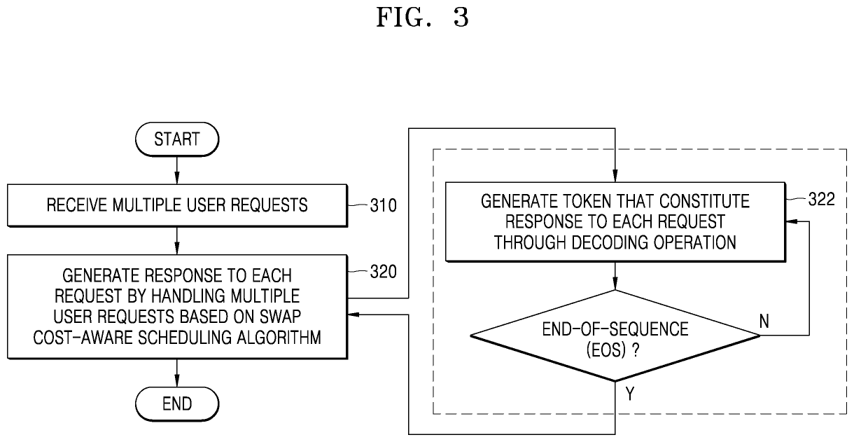

FIG. 3 is a flowchart for describing operations of a server for handling multiple user requests, according to one or more embodiments of the present disclosure. In the following embodiments, operations may be performed sequentially, in a different order, in parallel, or with some operations skipped or repeated.

In operation 310, the server 100 may receive a plurality of user requests (e.g., simultaneously, asynchronously, across different time intervals).

The server 100 may receive requests simultaneously input from multiple client terminals through the communication interface, and prepare to generate a response to each request by registering the requests in a queue for processing.

The server 100 may manage the plurality of user requests in parallel. As it may not be possible to handle all the user requests at the same time, the server 100 may define and manage a state for each request. The request state may include, without limitation, ‘waiting’, ‘running’, ‘swapped’, ‘swapping out’, ‘swapping in’, ‘finished’, etc. Transition of the request state may be controlled by the scheduler.

In operation 320, the server 100 may generate a response to each request by processing the plurality of user requests based on the swap cost-aware scheduling algorithm. For example, the server 100 may individually generate a response to a request of a first user and a response to a request of a second user. The server 100 may generate a KV cache by performing a prefill operation for a request. The generated KV cache may be used during a decoding operation process.

The swap cost-aware scheduling algorithm may refer to an algorithm that calculates a cost for swap-in or swap-out, and swaps out a request being executed or swaps in the swapped request based on the swap cost, thereby controlling priorities of requests to be handled in the server 100. The swap cost-aware scheduling algorithm may include performing operations such as swap-in, swap-out, and decoding at each scheduling time stage.

Operation 320 includes operation 322, a repetitive token generation process managed by the scheduler. In operation 322, for each request, the server 100 may generate tokens that constitute a response to the request through a decoding operation. One request corresponds to one response. One response may correspond to (e.g., include) a plurality of tokens. The server 100 may repeatedly perform operation 322 to sequentially generate tokens one by one, which correspond to (e.g., constitute) a response to a request. When each token is generated, the scheduler is executed to determine which request is to be handled with priority. When an end of sequence (EOS) token is generated, the server 100 may recognize this as a completion signal of token generation, complete the token generation process and generate a final response.

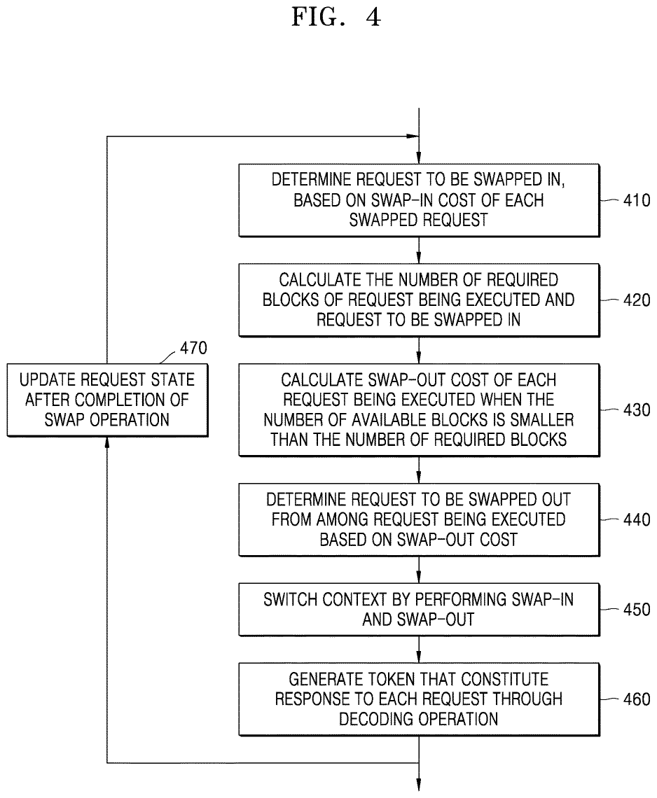

Each time a token is generated, the scheduler responsible for scheduling may perform a swap operation to manage the memory resource. The scheduler may use the swap cost-aware scheduling algorithm that calculates swap costs and determines whether to perform swapping. Specific operations of the swap cost-aware algorithm will be further described in detail with reference to FIG. 4.

FIG. 4 is a flowchart for describing operations of a scheduling algorithm according to which a server handles multiple user requests, according to one or more embodiments of the present disclosure. In the following embodiments, operations may be performed sequentially, in a different order, in parallel, or with some operations skipped or repeated.

In operation 410, the server 100 may determine a request to be swapped in, based on a swap-in cost of each of swapped requests.

The server 100 may swap-in at least a portion of the swapped requests to maximize the usage of the memory resource. The swapped request may refer to a request that was being executed has been swapped out in a time stage before the current scheduling time stage.

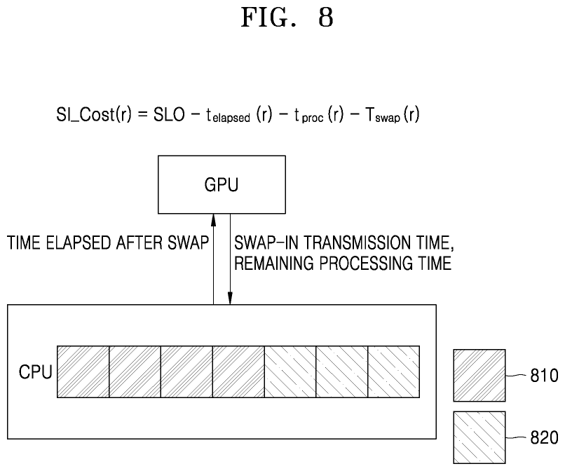

The server 100 may calculate a swap-in cost of each of the swapped requests. The server 100 may calculate a swap elapsed time of the request, a remaining processing time and a swap-in transmission time. The server 100 may calculate a swap-in cost of each of the swapped requests, based on the SLO for latency and the swap-in transmission time. A specific method by which the server 100 calculates the swap-in transmission time and the swap-in cost will be further described later in connection with FIG. 8.

The server 100 may determine a request to be swapped in from among the swapped requests, based on the swap-in cost. For example, the server 100 may determine a request having the lowest swap-in cost from among the swapped requests as a request to be swapped in. In one or more embodiments, there may be a plurality of requests to be swapped in.

In operation 420, the server 100 may calculate the number of required blocks (e.g. first blocks) of the requests being executed and the request(s) to be swapped in. Required blocks refer to the memory blocks that must be allocated to process one or more requests. For example, required blocks include blocks for requests being executed and request(s) to be swapped in.

The server 100 may identify the number of required blocks of the requests being executed. For example, when the first request and the second request are currently being executed, the server 100 may calculate the number of required blocks of the first request and the second request. The server 100 may also calculate the number of required blocks of the request determined to be swapped in.

In operation 430, the server 100 may calculate a swap-out cost of each of the requests being executed, when the number of available blocks (e.g. second blocks) is smaller than the number of required blocks.

That there is a swapped request determined to be swapped in and the number of required blocks of the requests being executed and the request to be swapped in is larger than the number of available blocks may refer to at least a portion of the requests being executed are to be swapped out in order to swap in a swapped request. The server 100 may calculate a swap-out cost of each of the requests being executed, based on at least one of transmission latency caused by swap-out of the request, throughput reduction caused by swap-out of the request, or future memory pressure caused by the request.

In one or more embodiments, the server 100 may dynamically adjust weights to be applied to a cost of the transmission latency, a cost of the throughput reduction and a cost of the future memory pressure, based on at least one of the SLO for latency, a load condition of the server 100 and a memory usage state.

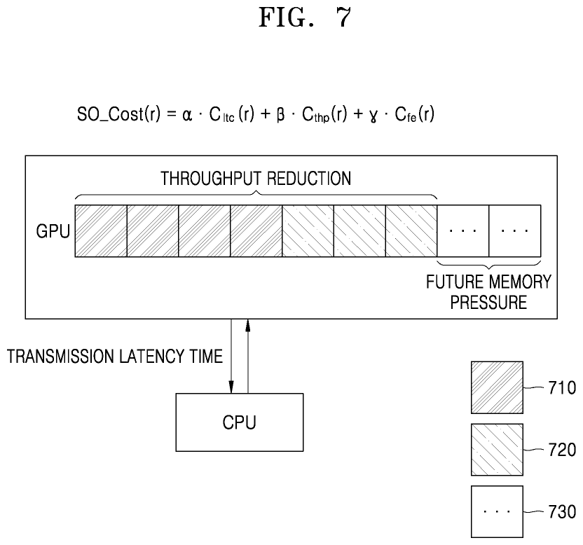

A specific method by which the server 100 calculates the swap-out cost will be further described later in connection with FIG. 7.

In operation 440, the server 100 may determine a request to be swapped out from among the requests being executed, based on the swap-out cost. For example, the server 100 may determine a request having the lowest swap-out cost from among the requests being executed as a request to be swapped out. In one or more embodiments, there may be a plurality of requests to be swapped out. In one or more embodiments, the server 100 may determine to swap out only a portion of the blocks occupied by the requests being executed.

In operation 450, the server 100 may switch contexts by performing swap-in and swap-out.

The server 100 may asynchronously switch contexts by interleaving the swap-in and swap-out with a decoding operation. For example, while generating tokens of a request being executed by the GPU, the server 100 may perform swapping of the KV cache of another request determined to be swapped in or swapped out in parallel or asynchronously. For example, while generating one token through the decoding operation of request 1, the server 100 may swap out the KV cache of request 2 (e.g., from GPU to CPU) and swap in the KV cache of request 3 (e.g., from CPU to GPU). In other words, while tokens for a request are being generated through a decoding operation, swapping in and swapping out other requests may be performed in a background stream. The server 100 may interleave the decoding operation task and the swap-in/swap-out task, thereby reducing the overall latency.

In operation 460, the server 100 may generate tokens that constitute a response to each request through a decoding operation.

The server 100 may generate tokens that correspond to (e.g., constitute) a response to each request to generate responses to the rest of the requests being executed other than the requests to be swapped in or swapped out. At each time stage of the scheduling algorithm, one token may be generated.

In operation 470, the server 100 may update the request state after completion of the swap operation. For example, the request state may include, but not exclusively to, ‘waiting’, ‘running’, ‘swapped’, ‘swapping out’, ‘swapping in’, ‘finished’, etc. Transitions of the request state may be updated at each time stage of the scheduling algorithm.

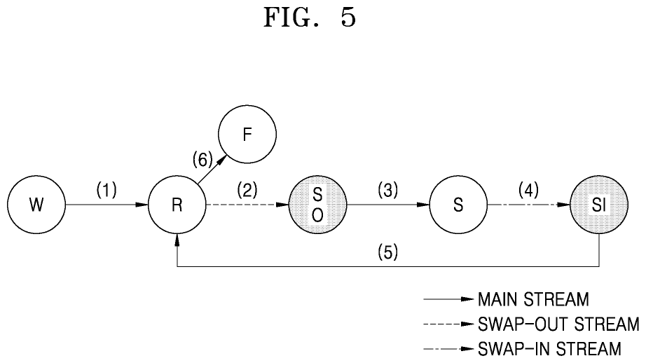

FIG. 5 is a diagram for describing a state for each request managed by a scheduling algorithm, according to one or more embodiments of the present disclosure.

Referring to FIG. 5, illustrated are state transitions among requests in a scheduler.

The server 100 may update the state for each request at every scheduling time stage of the cost-aware scheduling algorithm. The request state may include, but not exclusively to, ‘waiting’, ‘running’, ‘swapped’, ‘swapping out’, ‘swapping in’, ‘finished’, etc. Transitions of the request state may be controlled by the scheduler.

The request state ‘waiting (W)’ may refer to a state of waiting to be scheduled. For example, a new request received by the server 100 from the user may be classified as ‘waiting’.

The request state ‘running (R)’ may refer to a state in which a prefill or decoding operation is being performed. For example, it may correspond to a prefill operation that generates the KV cache for the entire new input at once, and a decoding operation that sequentially generates tokens one by one, that constitute a response based on the KV cache generated through the prefill operation.

The request state ‘swapped(S)’ may refer to a state in which the entire KV cache or partial KV cache of a request that was being executed has been swapped out. For example, when a request that was being executed in GPU memory has just been swapped out into CPU memory, the state of the request may be transitioned to ‘swapped’.

The request state ‘swapping out (SO)’ may refer to a state in which swap-out of the request is currently being in progress in the background. For example, after a request is determined to be swapped out, the swap-out operation of the request is initiated and the request state is transitioned to ‘swapping out’. The swap-out operation may be performed in a background stream (swap-out stream) separate from the main stream that generates response tokens. Once the swap-out operation is completed through one or more scheduling time stages, the request state may be transitioned to ‘swapped’.

The request state ‘swapping in (SI)’ may refer to a state in which swap-in of the request is currently being in progress in the background. For example, after a request is determined to be swapped in, a swap-in operation of the request is initiated and the request state is transitioned to ‘swapping in’. The swap-in operation may be performed in a background stream (swap-in stream) separate from the main stream that generates response tokens. Once the swap-in operation is completed through one or more scheduling time stages, the request, which has been swapped in, starts to be handled in the main stream, and the request state may be transitioned to ‘running’.

The request state ‘finished (F)’ may refer to a state in which a completion token indicating that processing of the request has been completed is generated. The completion token may also be referred to as an EOS token. While the request state is ‘running’, the server 100 sequentially generates tokens of a response to the request. When the EOS token is generated by repeating token generation, the server 100 may recognize the EOS token as a completion signal of token generation, complete token generation and generate a final response.

Referring to the request state transitions illustrated in FIG. 5, a newly received request enters the waiting (W) state. Afterward, the request is transitioned to the running (R) state in which a prefill operation and a decoding operation are performed. When the request being executed is determined to be swapped out, the request is swapped out in a background swap-out stream and transitioned to the swapping out (SO) state. When the swap-out is completed, the request is transitioned into the swapped(S) state, and afterward, when the request is determined to be swapped back in, the request is swapped in in a background swap-in stream and transitioned into the swapping in (SI) state. The swapped-in request turns back into the running (R) state, and is transitioned into the finished (F) state when the completion token is generated by repeating token generation.

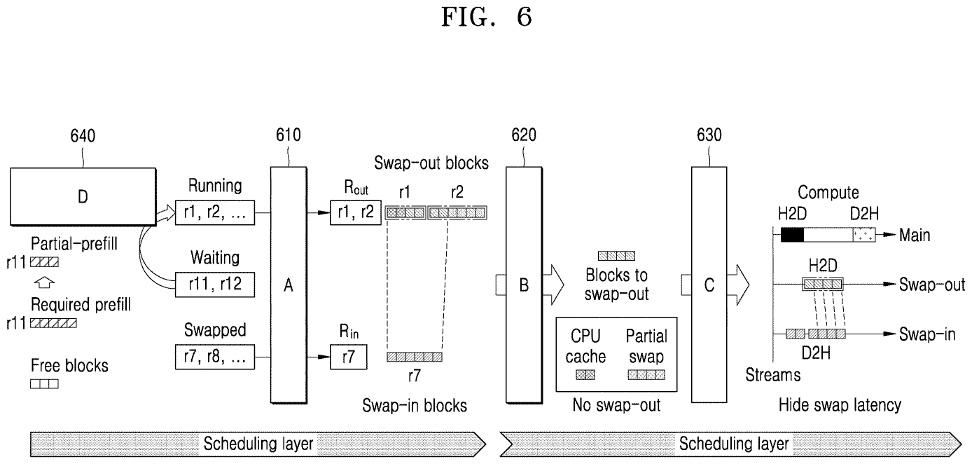

FIG. 6 illustrates the overview of how a server handles multiple user requests, according to one or more embodiments of the present disclosure.

Referring to FIG. 6, to handle multiple user requests, the server 100 may use a cost-aware context switching module (A) 610, a fine-grained swap-out module (B) 620, an asynchronous context switching module (C) 630, and a partial prefill scheduling module (D) 640. The partial prefill scheduling module 640 and the cost-aware context switching module 610 correspond to a scheduling layer responsible for determining what data to process and how to process the data, and the fine-grained swap-out module 620 and the asynchronous context switching module 630 correspond to a mechanism layer responsible for performing a determined operation.

The cost-aware context switching module 610 may calculate swap costs, and switch contexts (KV caches) based on the swap costs. For example, the cost-aware context switching module 610 may determine to swap in r7 based on the swap-in costs from among requests {r7, r8, . . . } that are in the swapped state. The cost-aware context switching module 610 may determine a request to be swapped out, based on the number of memory blocks of the request to be swapped in and swap-out costs. For example, the cost-aware context switching module 610 may determine to swap out r1 and r2 based on the swap-out costs from among requests {r1, r2, . . . } that are in the running state.

The fine-grained swap-out module 620 may use a fine-grained swap-out policy for memory optimization. Based on a defined condition, only partial blocks of the request to be swapped out may be swapped out. The defined condition may include whether there is a previous swap history of the request to be swapped out, whether the number of blocks of the request to be swapped out is larger than the number of required blocks, etc., but is not limited thereto.

For example, r1 that is determined to be swapped out may be a request that has a history of being previously swapped out, has been swapped back in and is currently being executed (running). In this case, the fine-grained swap-out module 620 may skip swap-out of blocks that has already been cached in the CPU memory but evict the blocks, and may swap out only the remaining cache blocks that are not present in the CPU memory. For example, according to the number of required blocks of r7 determined to be swapped in, r2 determined to be swapped out does not need to have the entire blocks of r2 be swapped out. In this case, the fine-grained swap-out module 620 may swap out only a portion of the blocks of r2.

The asynchronous context switching module 630 may perform swap-in or swap-out in the background stream separately from the main stream in which a decoding operation is performed. For example, the asynchronous context switching module 630 may perform asynchronous swap-out (device to host (D2H)) and asynchronous swap-in (host to device (H2D)) tasks, allowing them to overlap with mainstream GPU computation.

The partial prefill scheduling module 640 may opportunistically schedule the prefill operation of a pending request. The partial prefill scheduling module 640 may schedule the prefill operation on at least a portion of the pending requests based on the number of available memory blocks.

The prefill operation is performed on the whole pending request. The partial prefill scheduling module 640 may perform opportunistic scheduling that enables the prefill operation to be performed not on all but only a portion of the pending request when there is a free space in the GPU memory. For example, when the server 100 intends to prefill r11 of the requests {r11, r12, . . . } in the waiting state, the number of required blocks of r11 is five. However, the number of available memory blocks in the current GPU may be three. In this case, the partial prefill scheduling module 640 may perform partial prefill scheduling that enables the prefill operation to be performed only on a portion of the request r11 based on the number of available memory blocks.

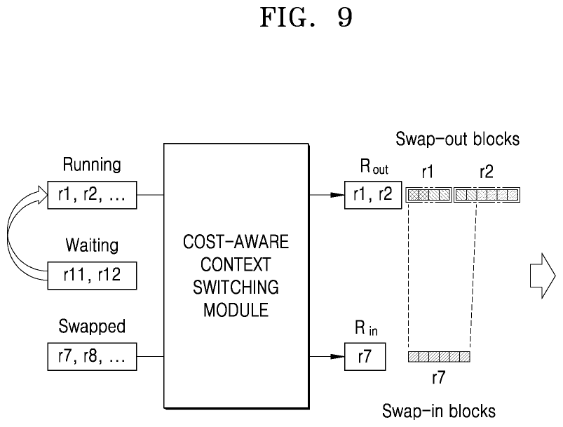

Operations of each module shown in FIG. 6 will be further described in more detail in connection with FIGS. 9 to 12.

FIG. 7 is a diagram for describing operations of a server for calculating swap-out costs and determining a request to be swapped out, according to one or more embodiments of the present disclosure.

Referring to FIG. 7, illustrated is a request being processed in the GPU. The memory in the GPU may be occupied by prefill blocks 710 and decoding blocks 720 of a request. Free blocks 730 represent memory blocks that are not currently occupied, and may become the decoding blocks 720 as the request continues to be processed.

The server 100 may calculate a swap-out cost for the requests being executed. The server 100 may calculate the swap-out cost, based on at least one of transmission latency caused by swap-out of the request, throughput reduction caused by the swap-out of the request, or future memory pressure caused by the request. The swap-out cost may be defined by Equation 1 below:

SO_Cost(r)=α·C_{ltc}(r)+β·Cₜₕₚ(r)+γ·C_{fe}(r) (1)

In Equation 1, α, β, γ denote weights to be applied to the respective costs. A sum of the weights may be ‘1’, and a default value of each weight may be set to ⅓. The weight values may be dynamically changed based on at least one of the load condition or the memory usage state of the server 100.

The first term C_{ltc}(r), the first swap-out cost may be defined by Equation 2 below:

C_{ltc}(r)=n_{blks}(r)·t_{blk} (2)

C_{ltc}(r) may denote transmission latency caused by swap-out of the request r, and may denote a PCIe transmission cost of the request being executed transmitted from GPU to CPU. Equation 1, n_{blks}(r) may denote the number of KV blocks currently allocated to the request r, and t_{blk} may denote a transmission time of the KV blocks between GPU and CPU. For example, C_{ltc}(r) may denote a time for which the prefill blocks 710 and the decoding blocks 720 are transmitted from GPU to CPU.

The second term Cₜₕₚ(r), the second swap-out cost may be defined by Equation 3 below:

$${C}_{thp} ( r ) = ( \frac{{t}_{s} ( R \backslash r )}{{n}_{s} ( R \backslash r )} - \frac{{t}_{s} ( R )}{{n}_{s} ( R )} ) \cdot {n}_{s} ( r ) \cdot ( 1 + k ( r ) ) \qquad ( 3 )$$

Cₜₕₚ(r) may denote throughput reduction caused by the swap-out of the request r. In Equation 3, R may denote the entire requests, r may denote a current request, and R/r refers to a difference set. tₛ may denote a time for handling the request, and nₛ may denote the number of processed tokens. K(r) is a term to reflect an expected future stage and is defined as n_{rem_toks}(r)/nₛ(r), and n_{rem_toks}(r) may denote remaining tokens to be generated or pre-fetched. For example, C_{ltc}(r) may denote throughput reduction when the prefill blocks 710 and the decoding blocks 720 are transmitted from GPU to CPU.

The third term C_{fe}(r), the third swap-out cost may be defined by Equation 4 below:

C_{fe}(r)=−n_{rem_blks}(r)·t_{blk} (4)

C_{fe}(r) may denote a future memory pressure caused by the request r, and the future memory pressure may be referred to as future eviction. In Equation 4, n_{rem_blks}(r) may denote the (estimated) number of KV blocks required for the request r in the future, and t_{blk} may denote a transmission time of the KV blocks between GPU and CPU. For example, C_{fe}(r) reflects the prediction indicating that the free blocks 730 are occupied in the future.

The server 100 may determine a request to be swapped out based on the swap-out cost. For example, the server 100 may select a request set Rout for which minimum B blocks are to be swapped out while minimizing the swap-out cost without violating latency SLO. This may be defined in Equations 5 and 6 below:

$${min}_{{R}_{out}} {\sum }_{r ∈ {R}_{out}} SO\_Cost ( r ) \qquad ( 5 )$$

$$s . t . {R}_{out} = \{ r ∈ R \vert RTT ( r ) + δ < SLO \} , {\sum }_{r ∈ {R}_{out}} {n}_{blks} ( r ) \geq B \qquad ( 6 )$$

In Equation 6, 6 may denote a certain margin, B denotes the number of required blocks that have been swapped in, and a round-trip time RTT(r) denotes an estimated time taken to swap in and resume the evicted request r and generate the subsequent output token. The round-trip time RTT(r) of the request r may be defined in Equation 7 below:

$$R T T ( r ) = ( {\sum }_{{r}^{′} ∈ SO ⋃ {R}_{o u t}} {n}_{blks} ( {r}^{′} ) + 2 \cdot {n}_{blks} ( r ) ) \cdot {t}_{blk} + {t}_{proc} ( r ) \qquad ( 7 )$$

In Equation 7, t_{blk} may denote a transmission time of KV blocks between GPU and CPU through PCIe. n_{blk} may denote the number of blocks for the request. t_{proc}(r) denotes a time taken to process the subsequent token. For decoding, t_{proc}(r) may be defined as a time required to process a single token or a time required to process a predefined number (two or more) of tokens. Alternatively, for decoding, as it is not possible to predict when the EOS token will be generated, t_{proc}(r) may be determined as a time required to process a dynamically determined number of tokens based on the length of the input request, the number of generated tokens, etc. For prefill, t_{proc}(r) may be defined as a time required to process all the input tokens. r′ may denote requests (e.g., requests in the swapping out state or other requests in Rₒᵤₜ) other than the request r.

The server 100 may select the swap-out request set Rₒᵤₜ from among the entire requests R being executed, and determine a request to be swapped out based on a swap-out cost for each request included in Rₒᵤₜ. In an embodiment, there may be one or more requests determined to be swapped out.

In one or more embodiments, the server 100 may dynamically adjust the weights to be applied to the swap-out costs based on the latency SLO, the load condition of the server 100, and the memory usage state. The swap-out cost may include a cost of transmission latency C_{ltc}, a cost of throughput reduction Cₜₕₚ, and a cost of future memory pressure C_{fe}.

For the latency SLO, latency defined for e.g., inter-token latency (ITL), time per output tokens (TPOT), etc., may be used, without being limited thereto. The load condition of the server 100 may be measured based on an amount of requests and the number of tokens to be generated at each processing step. The memory usage state may be defined according to whether the memory usage of the server 100 exceeds a threshold.

For example, when the server 100 is heavily loaded, the server 100 may allocate higher weights in the order of latency, throughput, and memory pressure, e.g., C_{ltc}: maximum, Cₜₕₚ: medium, and C_{fe}: minimum. In this case, the server 100 may minimize latency by prioritizing the existing sequence (e.g., prioritizing decoding), manage an increase in throughput by managing the addition of a new sequence in the current state or changing it only within a certain range, ignore the memory pressure and allow a temporary increase in memory usage.

For example, when the server 100 has high memory pressure, the server 100 may allocate higher weights in the order of memory pressure, latency, and throughput, e.g., C_{fe}: maximum, C_{ltc}: medium, and Cₜₕₚ: minimum. In this case, the server 100 may secure a memory space by terminating or swapping out an unnecessary sequence, manage latency by prioritizing the active sequence, and reduce throughput by restricting addition of a new sequence.

For example, when the server 100 has a light load or a sufficient memory space, the server 100 may allocate higher weights in the order of throughput, memory pressure and latency, e.g., Cₜₕₚ: maximum, C_{fe}: medium, and C_{ltc}: minimum. In this case, the server 100 may maximize throughput by adding a new sequence, manage memory pressure by terminating or swapping out an unnecessary sequence, and slow down processing speed of the existing sequence (allowing an increase in latency).

FIG. 8 is a diagram for describing operations of a server for calculating a swap-in cost and determining a request to be swapped in, according to one or more embodiments of the present disclosure.

Referring to FIG. 8, illustrated is a request swapped out from the GPU and cached in the CPU. Blocks cached in the CPU memory may include prefill blocks 810 and decoding blocks 820.

The server 100 may calculate swap-in costs for the swapped requests. The server 100 may calculate a swap-in transmission time for each of the swapped requests. At least some of the swapped requests may form a swap-in request set Rin.

The swap-in transmission time T_{swap}(r) of the request r may be defined in Equation 8 below:

$${T}_{swap} ( r ) = ( {\sum }_{{r}^{′} ∈ SI ⋃ {R}_{in}} {n}_{blks} ( {r}^{′} ) + {n}_{blks} ( r ) ) \cdot {t}_{blk} \qquad ( 8 )$$

In Equation 8, t_{blk} may denote a transmission time of KV blocks between GPU and CPU through PCIe. n_{blk} may denote the number of blocks for the request. r′ denotes requests (e.g., requests in the swapping in state or other requests in Rᵢₙ) other than the request r.

The server 100 may calculate a swap-in cost of each of the swapped requests (swapped-in requests Rin) based on the SLO for the swap-in transmission time, a swap elapsed time, a remaining processing time and latency. The swap-in cost SI_Cost(r) of the request r may be defined in Equation 9 below: The swap-in cost serves to estimate how close each request r is to a possibility that the request r fails to satisfy the SLO.

SI_Cost(r)=SLO−t_{elapsed}(r)−t_{proc}(r)−T_{swap}(r) (9)

In Equation 9, t_{elapsed} may denote an elapsed time after the request r is swapped, and t_{proc}(r) denotes a time taken to process (decode or prefill) the subsequent token.

The server 100 may determine a request having a lower swap-in cost to be swapped in. The request having a lower swap-in cost refers to one that is closer to the possibility of failing to satisfy the latency SLO. For example, the longer the elapsed time after being swapped, the longer the token processing time after being swapped in, or the longer the swap-in transmission time, the higher the possibility of failing to satisfy the latency SLO, so the swap-in cost appears lower.

The server 100 may calculate a swap-in cost for each of the swapped requests, and determine a request to be swapped in from among the swapped requests based on the swap-in cost.

FIG. 9 is a diagram for describing operations of a server for performing cost-aware scheduling, according to one or more embodiments of the present disclosure.

The server 100 may use a cost-aware context switching module to perform scheduling that switches contexts. The server 100 may identify states of the requests. For example, the server 100 may identify that the requests {r1, r2, . . . } are in the running state, requests {r11, r12} are in the waiting state, and the requests {r7, r8, . . . } are in the swapped state. The running state may refer to a state in which a prefill or decoding operation is currently being performed, the waiting state may refer to a state of waiting to be scheduled, and the swapped state may refer to a state in which the whole or part of the request that was being in the running state has been swapped out.

The server 100 may determine a swap-in request set Rᵢₙ={r7} from among the swapped requests {r7, r8, . . . }. As illustrated in FIG. 9, the request contained in the swap-in request set may be r7. It is not, however, limited thereto, and there may be one or more requests contained in the swap-in request set. The server 100 may calculate a swap-in cost for each of the requests in the swap-in request set, and determine a request having the lowest swap-in cost to be swapped in. As illustrated in FIG. 9, request r7 may be determined to be swapped in.

The server 100 may determine a swap-out request set Rₒᵤₜ={r1, r2} from among the requests being executed {r1, r2, . . . }. As illustrated in FIG. 9, requests contained in the swap-out request set may be r1 and r2. It is merely an example, and there may be one or more other requests contained in the swap-out request set. The server 100 may calculate a swap-out cost for each of the requests in the swap-out request set, and determine a request having the lowest swap-out cost to be swapped out. As illustrated in FIG. 9, requests r1 and r2 may be determined to be swapped out.

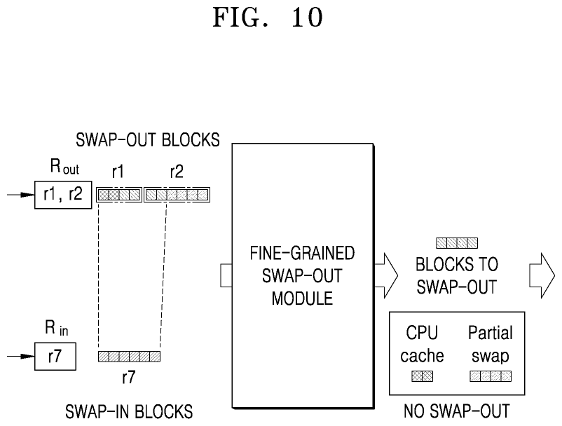

FIG. 10 is a diagram for describing operations of a server for performing fine-grained swap-out, according to one or more embodiments of the present disclosure. The description of FIG. 10 follows on from the illustration of FIG. 9.

The server 100 may use the fine-grained swap-out module to perform swap-out while optimizing the memory usage. The server 100 may swap out the whole or part of the request, based on the number of required blocks. For example, based on a defined condition, the server 100 may perform swap-out only partial blocks of the request to be swapped out. The defined condition may include whether there is a previous swap history of the request to be swapped out, whether the number of blocks of the request to be swapped out is larger than the number of required blocks, etc., but is not limited thereto.

For example, the request to be swapped in, which is determined based on the swap-in cost in the previous stage may be r7. The request r7 requires six blocks. The server 100 may swap out only six blocks of the swap-out request set Rₒᵤₜ={r1, r2} to secure a memory space to handle the request r7. In an embodiment, the server 100 may further secure an extra memory space by swapping out a larger number of blocks than the number of required blocks.

The server 100 may determine a request to be swapped out from the swap-out request set Rₒᵤₜ={r1, r2} based on the swap-out costs. As illustrated in FIGS. 10, r1 and r2 are the requests to be swapped out, which are determined based on the swap-out costs, and it is assumed that r1 has a higher priority than r2.

The server 100 may swap out not all but only part of the requests to be swapped out. In other words, the server 100 may determine blocks to be swapped out and blocks not to be swapped out for the request.

For example, the server 100 may swap out only part of the request based on whether the request to be swapped out has a history of being swapped previously. r1 may be a request that has a history of being swapped out previously and that has been swapped back in and is currently being executed. For example, r1 has four blocks, two of which were swapped out in the previous stage and has been swapped back in by the scheduler and the remaining two of which may have additionally been generated in the current running stage.

Even after swapping the request, that was swapped out, into GPU memory, the server 100 may maintain the swapped-out blocks in CPU memory. As the blocks that were swapped out and then has been swapped back in are maintained in the CPU memory, the server 100 skips swapping out but directly evicts the blocks that have the history of being swapped-out previously and swaps out only the blocks that have no history of being swapped out, thereby saving unnecessary transmissions required for swap-out operations. In the meantime, the swap-out cost as described in connection with FIG. 7 may be calculated by reflecting the omission of swap-out for some blocks. For example, when there are m blocks in the GPU and k blocks are already cached in the CPU memory, where m>k, the number of blocks considered in C_{ltc}(r) and Cₜₕₚ(r) may be reflected as m-k.

For example, the server 100 may swap out only part of the request based on whether the number of blocks of the request to be swapped out is larger than the number of required blocks. For example, although r2 is a request to be swapped out, it may be swapped out later than r1 according to the swap-out cost. Even when the server 100 secures four blocks by evicting or swapping out the blocks of r1, two or more blocks need to be secured through additional swap-out to satisfy the number of blocks required to swap in r7 (e.g., six or more blocks are required for r7). In this case, the server 100 may swap out only part of the blocks of r2 based on the number of required blocks. For example, the server 100 may swap out only two of the six blocks of r2. A criterion for the server 100 to swap partial blocks of the request may be, for example, to swap out from the beginning of the sequence, but is not limited thereto.

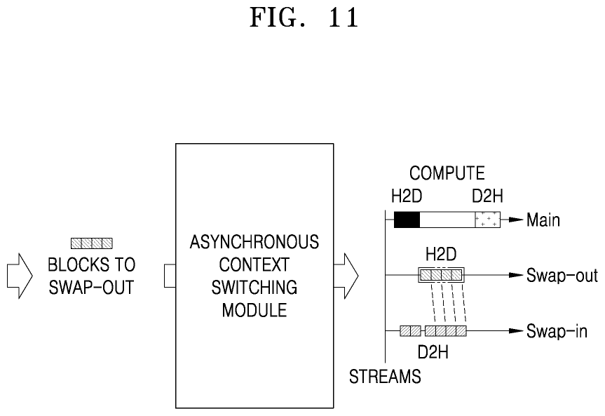

FIG. 11 is a diagram for describing operations of a server for performing asynchronous context switching, according to one or more embodiments of the present disclosure. The description of FIG. 11 follows on from the illustration of FIGS. 9 and 10.

The request r7 to be swapped in, which is determined in the illustration of FIG. 10, is comprised of six blocks. Swap-out of two blocks already cached in the CPU among the blocks of r1 is omitted, and there are a total of four blocks determined to be swapped out: two of r1 and two of r2.

Referring to a swap-in stream, as two blocks, a portion of the request r1 to be swapped in are already cached in the CPU memory, the fine-grained swap-out module skips swap-out of the two blocks and the two blocks are in a state of being evicted. Hence, as the corresponding memory space is currently available, the two blocks, a portion of the blocks of r7 may be swapped in first.

Referring to a swap-out stream, the remaining two blocks of r1 and two partial blocks of r2 may be asynchronously swapped out in the background, thereby securing a memory space of four blocks. Turning back to the swap-in stream, the remaining four blocks of r7 may be asynchronously swapped in in the background.

The aforementioned swap-in stream and swap-out stream may be performed to overlap the main stream that performs GPU computation to generate response tokens for other requests. In this case, swap-ins and/or swap-outs of different requests that are performed at the same time may contend for the same memory area.

The server 100 may trace the transmission state of each memory block while asynchronously performing swap-ins or swap-outs. For example, the server 100 may update the state of the GPU block while tracing it. For example, the server 100 may update the state of a block that is being swapped out from the GPU to indicate that it is not possible to swap in the block simultaneously, and also update the sate of a block that is being swapped in to indicate that is not possible to swap out the block simultaneously. When the block is completely transmitted, the server 100 may update the state of the block to indicate that it is possible to reuse or overwrite the block. The server 100 may ensure safety of memory transfer even when swap-ins and swap-outs of different requests are simultaneously performed, by tracing transmission of block labels.

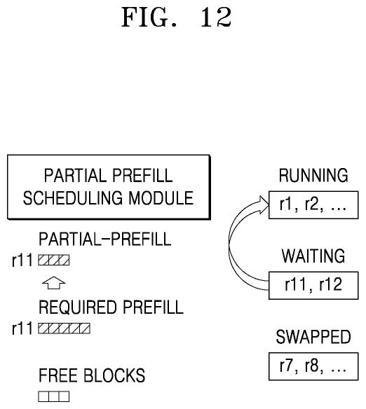

FIG. 12 is a diagram for describing operations of a server for performing partial prefill scheduling, according to one or more embodiments of the present disclosure. The description of FIG. 12 follows on from the illustration of FIGS. 9 and 11.

In some examples, the prefill operation is performed on the whole pending request. Hence, when free GPU memory is insufficient to allocate the entire KV cache, the traditional system suspends scheduling and waits until memory is released upon the completion of decoding for other requests. This may imply that even when a small amount of available space exists in memory, the available space may not be used, causing a head-of-line blocking problem despite the availability of the memory space.

To resolve this problem, the server 100 may perform opportunistic scheduling that allows the prefill operation to be performed for even a portion of the pending request rather than the entirety of the request. The server 100 may identify the number n_{s_toks} of tokens that may be processed with the available memory. This may be defined in Equations 10 below:

n_{s_toks}=available_blocks·tokens_per_blk (10)

The number of tokens per block may refer to the number (e.g., 8, 16, 32, etc.) of tokens that may be contained in one block. Based on the number n_{s_toks} of tokens that may be processed, the server 100 may allocate memory blocks and perform a partial prefill operation. After performing the partial prefill operation, the server 100 may dynamically allocate the remaining portions based on the available memory space to complete the entire prefill operation.

The opportunistic scheduling of the server 100 may be used in combination with the cost-aware scheduling. For example, when scheduling the requests by using the cost-aware scheduling, the server 100 may exclude the already partially prefilled tokens, and calculate a processing time t_{proc} for the remaining tokens. In other words, as the already prefill-processed tokens may be excluded, more precise determination of SLO-aware swap-in becomes possible.

Furthermore, the opportunistic scheduling of the server 100 may influence the determination of swap-out. As the request occupies the memory without generating any output until prefill is completed, it may impact future memory shortages. This is reflected when a cost C_{fe} of future memory pressure included in the swap-out cost is calculated. For example, as a request for which only the prefill operation is performed is expected to consume more KV cache blocks in the future, C_{fe} is calculated to have a greater value. C_{fe} is a negative-cost term, so having a greater value of C_{fe} implies that the swap-out cost becomes lower. As the server 100 swaps out a request having a lower swap-out cost, the server 100 may determine to swap out the partially prefilled request with priority.

Referring to FIG. 12, a small amount (e.g., three) of available blocks may exist in the current GPU. In this case, the server 100 may use the opportunistic scheduling to perform partial prefill on a portion of the requests in the waiting state by using the available blocks. For example, when the server 100 intends to prefill r11 among the requests {r11, r12, . . . } in the waiting state, the number of required blocks of r11 is five. However, as the number of available memory blocks in the current GPU is three, the server 100 may prefill only a portion of the request r11 based on the number of available memory blocks.

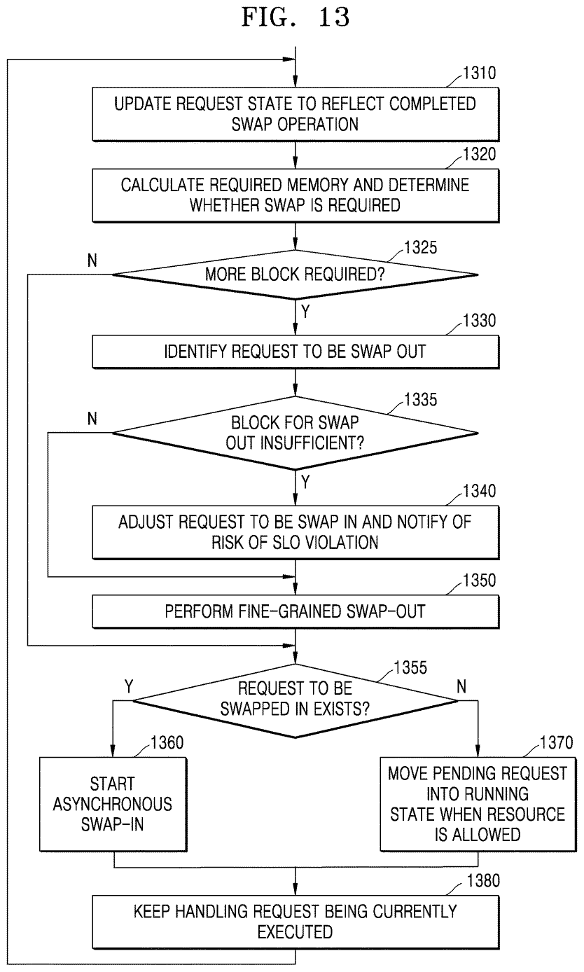

FIG. 13 is a flowchart for describing overall operations of a cost-aware scheduling algorithm according to which a server handles multiple user requests, according to one or more embodiments of the present disclosure.

Operations 1310 to 1380 may correspond to operations 410 to 470 of FIG. 4, and are provided to describe one or more operations of the cost-aware scheduling algorithm.

In operation 1310, the server 100 may update the request state to reflect the completed swap operation. In the current scheduling time stage, the server 100 may update the sate of a request that was swapped in or swapped out in the previous scheduling time stage. For example, the server 100 may update the state of a request being swapped out from running (R) to swapping out (SO), and change the sate of a request being swapped in from swapped(S) to swapping in (SI).

In operation 1320, the server 100 may calculate required memory and determine whether swapping is required.

The server 100 may calculate a swap-in cost for each of the requests in the swapped(S) state in order for the requests in the swapped(S) state to be handled again without violating the latency SLO. The server 100 may determine a request to be swapped in based on the swap-in cost. When the request to be swapped in is determined, the server 100 may calculate required memory. The required memory may include memory required by the requests currently being executed, and memory required by the request to be swapped in. Based on the required memory, the server 100 may determine whether swapping is required. The server 100 may calculate the number of required blocks of the requests being executed and the request to be swapped in.

In operation 1325, the server 100 may identify a current available memory space, and identify whether more memory blocks are required. For example, when the current available memory space is sufficient and no more blocks are required, the server 100 may proceed to operation 1355. For example, when the current available memory space is insufficient and more blocks are required, the server 100 may proceed to operation 1330.

In operation 1330, the server 100 may identify requests to be swapped out. The server 100 may calculate a swap-out cost for each of the requests being executed. Based on the swap-out cost of each of the requests being executed, the server 100 may determine one or more requests to be swapped out.

In operation 1335, the server 100 may identify whether blocks for swap-out are not sufficient. The server 100 may calculate the number of blocks occupied by the request to be swapped out, and compare the number of occupied blocks with the number of required blocks.

For example, when as much memory as the number of required blocks are not secured even after the requests determined to be swapped out are swapped out, the server 100 may perform operation 1340. In this case, in operation 1340, the server 100 may adjust the requests to be swapped in, and notify the system that there is a risk of SLO violation. For example, when the number of blocks occupied by the request to be swapped out is smaller than the number of required blocks, the server 100 may reduce the request to be swapped in. For example, the server 100 may reduce the number of requests to be swapped in or give up swap-in of the request to be swapped-in.

For example, when as much memory as the number of required blocks are secured through swap-out of the requests determined to be swapped out, the server 100 may perform operation 1350. In this case, in operation 1350, the server 100 may perform fine-grained swap-out. Based on a defined condition, the server 100 may perform swap-out only partial blocks of the request to be swapped out. The defined condition may include whether there is a previous swap history of the request to be swapped out, whether the number of blocks of the request to be swapped out is larger than the number of required blocks, etc., but is not limited thereto. This was described above, so the redundant description will not be repeated.

In operation 1355, the server 100 may identify whether there is a request to be swapped in.

When the request to be swapped in exists, the server 100 may perform operation 1360. In this case, the server 100 may perform swap-in or swap-out in the background stream separately from the main stream in which a decoding operation is performed.

When there is no request to be swapped in, the server 100 may perform operation 1370. In this case, the server 100 may move the pending request into the running state when the resources are available. When moving the pending request into the running state, the server 100 may perform a partial prefill operation through opportunistic scheduling. This was described above, so the redundant description will not be repeated.

In operation 1380, the server 100 may continue to handle the requests that are currently being executed. In addition or as an alternative to the aforementioned operations of the cost-aware scheduling, the server 100 may generate tokens that constitute a response to the request in the mainstream.

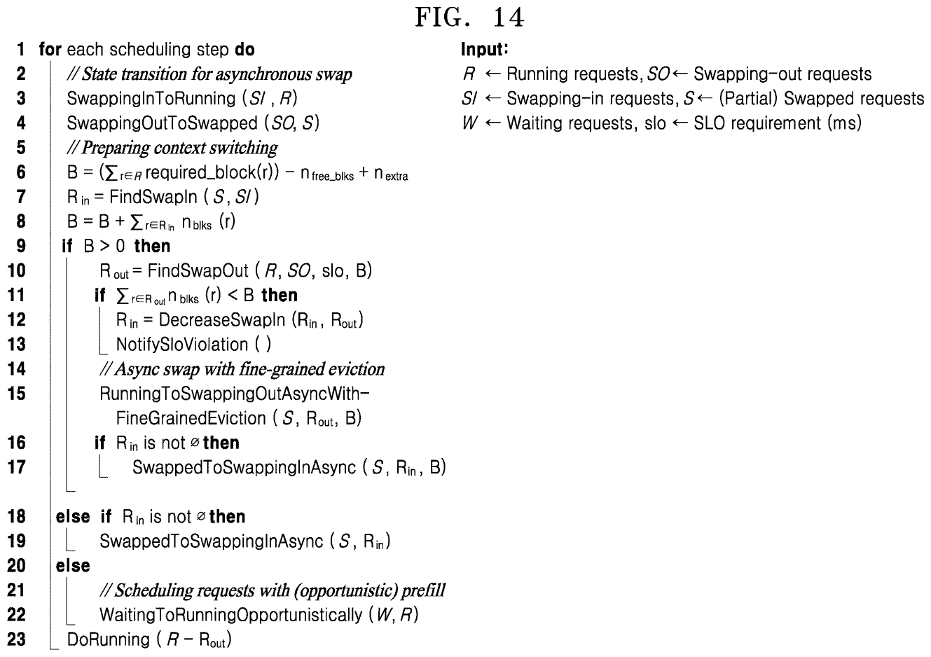

FIG. 14 illustrates a cost-aware scheduling algorithm, according to one or more embodiments of the present disclosure.

The server 100 may confirm asynchronous swap-in/swap-out transmissions and update the state of the request. For example, the request in the swapping-in (SI) state may be transitioned to the running state (R) when the KV cache is completely swapped in, and the request in the swapping-out (SO) state may be transitioned to the swapped(S) state when the swap-out is completed (lines 3 and 4).

The server 100 may calculate the number B of required blocks. The number B of required blocks may be a result of subtracting the number of available blocks from a sum of the numbers of required blocks of requests being executed. In an embodiment, a certain margin nₑₓₜᵣₐ may be added to the number of required blocks (line 6). The purpose of the certain margin is to prevent the process from being forcibly terminated due to insufficient memory while the request is being handled.

The server 100 may determine requests to be swapped in on a swap-in cost-aware basis, and add the number of blocks of the requests to be swapped in to the number of required blocks (lines 7 and 8).

When the number B of required blocks exceeds ‘0’, it may indicate that swap-out is required. The server 100 may find and select a request to be swapped out based on swap-out cost awareness (lines 9 and 10). When the number of blocks of requests to be swapped out is smaller than the number B of required blocks, the server 100 may reduce the request to be swapped in and notify the system that there is a risk of SLO violation (lines 11 to 13).

The server 100 may asynchronously perform swap-out operations. In this case, based on the defined conditions (e.g., a previous swap history, the number of blocks, etc.), the asynchronous swap-out may include performing swap-out only for partial blocks of the request to be swapped out.

When a request to be swapped in exists, the server 100 may asynchronously execute swap-in operations (lines 16 and 17).

When the number B of required blocks is 0 or less, an available memory space and swap-out may not be needed. When B is 0 or less and there is a request to be swapped in, the server 100 may asynchronously perform only swap-in operations without any swap-out operation (lines 18 and 19). When B is 0 or less and there is no request to be swapped in, the server 100 may execute opportunistic scheduling to use the remaining memory blocks. Using the opportunistic scheduling, the server 100 may perform the prefill operation for not all but only part of the pending request(s) when there is an available space in the GPU memory (lines 20 to 22).

The server 100 may generate tokens that constitute a response by handling the request that is being executed (line 23). When the EOS token that indicates the end of the sequence is generated, the server 100 may recognize the EOS token as a completion signal, and generate a final response.

The disclosure relates to a method of handling multiple user requests for a large language model (LLM) by using a scheduling algorithm that applies swap costs to optimize memory usage, and a server for performing the method.

One or more embodiments of the present disclosure may provide advantages in computer technology or any other technical field. The advantages may include, without limitation, efficient switching of multiple requests from multiple devices to one or more machine learning models (e.g., LLMs) deployed in the server (or any other computer systems) for model inferencing. The efficient switching of requests may result in reduced latency and efficient computing resource (e.g., GPU memory, CPU memory) usage. For example, deployed LLMs may dynamically control throughput, latency, and memory usage while handing multiple requests (e.g., queries) from various devices.

Technological objectives of the disclosure are not limited to what are mentioned above, and throughout the specification, it will be clearly appreciated by those of ordinary skill in the art that there may be other technological objectives unmentioned.

According to an aspect of the disclosure, a method by which a server handles multiple user requests for an LLM is provided.

The method may include receiving a plurality of requests, and generating a response to each of the plurality of requests by handling the plurality of requests by performing swap cost-aware scheduling.

The generating of the response to each of the plurality of requests may include generating tokens that constitute the response to each of the plurality of requests through a decoding operation managed by a scheduler.

The performing of the swap cost-aware scheduling may include determining a request to be swapped in based on a swap-in cost of each of swapped requests.

The performing of the swap cost-aware scheduling may include determining the number of first blocks corresponding to requests being executed and the request to be swapped in.

The performing of the swap cost-aware scheduling may include determining a swap-out cost of each of the requests being executed when the number of second blocks is less than the number of the first blocks, wherein the second blocks are available blocks.

The performing of the swap cost-aware scheduling may include determining a request to be swapped out from among the requests being executed, based on the swap-out costs.

The performing of the swap cost-aware scheduling may include switching contexts by performing swap-in and swap-out.

The performing of the swap cost-aware scheduling may include generating the tokens that constitute the response to each request through the decoding operation.

The determining of the swap-out cost may include determining the swap-out cost of each of the requests being executed, based on at least one of transmission latency caused by swap-out of a respective request, throughout reduction caused by swap-out of the respective request, or future memory pressure caused by the respective request.

The determining of the swap-out cost may include dynamically adjusting weights to be applied to a cost of the transmission latency, a cost of the throughput reduction and a cost of the future memory pressure, based on at least one of an SLO for latency, a load condition of the server or a memory usage state.

The determining of the request to be swapped in may include determining a swap-in transmission time for each of the swapped requests.

The determining of the request to be swapped in may include determining the swap-in cost of each of the swapped requests, based on at least one of the swap-in transmission time, a swap elapsed time of the request, the remaining processing time, or the SLO for latency.

The determining of the request to be swapped in may include determining a request to be swapped in from among the swapped requests based on the swap-in cost.

The performing of the swap cost-aware scheduling may include determining the number of third blocks occupied by the request to be swapped out.

The performing of the swap cost-aware scheduling may include reducing an amount of the swap-in when the number of the third blocks occupied by the request to be swapped out is less than the number of the first blocks.

The switching of the contexts may include asynchronously performing the swap-in and the swap-out by interleaving the swap-in and the swap-out with the decoding operation.

The switching of the contexts may include performing the swap-out for partial blocks of the request to be swapped out based on a defined condition.

The switching of the contexts may include maintaining a swapped-out block in CPU memory based on the swapped-out request is swapped into GPU memory.

The performing of the swap cost-aware scheduling may include performing only swap-in of the request to be swapped in, when the number of second blocks is greater than or equal to the number of first blocks.

The performing of the swap cost-aware scheduling may include performing a partial prefill operation that processes a portion of the pending request beforehand, based on the number of remaining available blocks.

According to an aspect of the disclosure, a server for handling multiple user requests for an LLM is provided. The server may include at least one accelerator, at least one processor, a communication interface and memory that stores instructions.

The instructions, when executed by the at least one processor, cause the server to receive a plurality of requests through the communication interface, and generate a response to each of the plurality of requests by handling the plurality of requests by performing swap cost-aware scheduling.

The instructions, when executed by the at least one processor, cause the server to generate tokens that constitute the response to each request through a decoding operation managed by a scheduler.

The instructions, when executed by the at least one processor, cause the server to determine a request to be swapped in, based on a swap-in cost of each of swapped requests.

The instructions, when executed by the at least one processor, cause the server to determine the number of first blocks corresponding to requests being executed and the request to be swapped in.

The instructions, when executed by the at least one processor, cause the server to determine a swap-out cost of each of requests being executed when the number of second blocks is less than the number of the first blocks, wherein the second blocks are available blocks.

The instructions, when executed by the at least one processor, cause the server to determine a request to be swapped out from among the requests being executed, based on the swap-out cost.

The instructions, when executed by the at least one processor, cause the server to switch contexts by performing swap-in and swap-out of data between the accelerator and the processor.

The instructions, when executed by the at least one processor, cause the server to generate the tokens that constitute the response to each request through the decoding operation.

The instructions, when executed by the at least one processor, cause the server to determine the swap-out cost for each of the requests being executed, based on at least one of transmission latency caused by swap-out of a respective request, throughput reduction caused by swap-out of the respective request, or future memory pressure caused by the respective request.

The instructions, when executed by the at least one processor, cause the server to dynamically adjust weights to be applied to a cost of the transmission latency, a cost of the throughput reduction and a cost of the future memory pressure, based on at least one of an SLO for latency, a load condition of the server or a memory usage state.

The instructions, when executed by the at least one processor, cause the server to determine a swap-in transmission time for each of the swapped requests.

The instructions, when executed by the at least one processor, cause the server to determine the swap-in cost of each of the swapped requests, based on at least one of the swap-in transmission time, a swap elapsed time of the request, a remaining processing time, or the SLO for latency.

The instructions, when executed by the at least one processor, cause the server to determine the request to be swapped in from among the swapped requests, based on the swap-in cost.

The instructions, when executed by the at least one processor, cause the server to determine the number of third blocks occupied by the request to be swapped out.

The instructions, when executed by the at least one processor, cause the server to reduce an amount of the swap-in when the number of the third blocks occupied by the request to be swapped out is less than the number of the first blocks.

The instructions, when executed by the at least one processor, cause the server to asynchronously perform the swap-in and the swap-out by interleaving the swap-in and the swap-out with the decoding operation.

The instructions, when executed by the at least one processor, cause the server to perform the swap-out for partial blocks of the request to be swapped out, based on a defined condition.

The instructions, when executed by the at least one processor, cause the server to maintain swapped-out blocks in CPU memory based on swapping a swapped-out request into GPU memory.

The instructions, when executed by the at least one processor, cause the server to perform only swap-in of the request to be swapped in, when the number of the second blocks is not smaller than the number of the first blocks.

The instructions, when executed by the at least one processor, cause the server to perform a partial prefill operation that processes a portion of pending requests beforehand, based on the number of remaining available blocks.

In the meantime, embodiments of the disclosure may be implemented in the form of a recording medium that includes computer-executable instructions such as the program modules executed by the computer. Computer-readable mediums may be an arbitrarily available medium that may be accessed by the computer, including volatile, non-volatile, removable, and non-removable mediums. The computer-readable medium may also include a computer storage medium and a communication medium. The computer storage medium includes all the volatile, non-volatile, removable, and non-removable mediums implemented by an arbitrary method or technology for storage of information, such as computer-readable instructions, data structures, program modules, or other data. The communication medium may include other data of modulated data signals such as computer-readable instructions, data structures, or program modules.

The computer-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store, directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Several embodiments have been described, but a person of ordinary skill in the art will understand and appreciate that various modifications can be made without departing the scope of the disclosure. Thus, it will be apparent to those of ordinary skill in the art that the disclosure is not limited to the embodiments described, but can encompass not only the appended claims but the equivalents. For example, an element described in the singular form may be implemented as being distributed, and elements described in a distributed form may be implemented as being combined.

The scope of the disclosure is defined by the appended claims, and it will be understood by those of ordinary skill in the art that various changes in form and details may be made without departing from the spirit and scope of the disclosure as defined by the appended claims and their equivalents.

What is claimed is:

1. A method by which a server handles multiple user requests for a large language model (LLM), the method comprising:
receiving a plurality of requests; and
generating a response to each of the plurality of requests by handling the plurality of requests by performing swap cost-aware scheduling,
wherein the generating of the response to each of the plurality of requests comprises generating tokens that constitute the response to each of the plurality of requests through a decoding operation managed by a scheduler, and
wherein the performing of the swap cost-aware scheduling comprises performing operations at each scheduling time stage, the operations comprising:
based on a swap-in cost of each of swapped requests, determining a request to be swapped in;
determining a number of first blocks corresponding to requests being executed and the request to be swapped in;
determining a swap-out cost of each of the requests being executed when a number of second blocks is less than the number of the first blocks, wherein the second blocks are available blocks;
determining a request to be swapped out from among the requests being executed, based on the swap-out cost;
switching contexts by performing swap-in and swap-out; and
generating the tokens that constitute the response to each request through the decoding operation.

2. The method of claim 1, wherein the determining of the swap-out cost comprises determining the swap-out cost of each of the requests being executed, based on at least one of transmission latency caused by swap-out of a respective request, throughput reduction caused by swap-out of the respective request, or future memory pressure caused by the respective request.

3. The method of claim 2, wherein the determining of the swap-out cost comprises dynamically adjusting weights to be applied to a cost of the transmission latency, a cost of the throughput reduction and a cost of the future memory pressure, based on at least one of a service level objective (SLO) for latency, a load condition of the server or a memory usage state.

4. The method of claim 1, wherein the determining of the request to be swapped in comprises:
determining a swap-in transmission time for each of the swapped requests;
determining the swap-in cost of each of the swapped requests, based on at least one of the swap-in transmission time, a swap elapsed time of the swapped request, a remaining processing time, or the SLO for latency; and
determining the request to be swapped in from among the swapped requests, based on the swap-in cost.

5. The method of claim 1, wherein the performing of the swap cost-aware scheduling comprises
determining a number of third blocks occupied by the request to be swapped out; and
reducing an amount of the swap-in when the number of the third blocks occupied by the request to be swapped out is less than the number of the first blocks.

6. The method of claim 1, wherein the switching of the contexts comprises asynchronously performing the swap-in and the swap-out by interleaving the swap-in and the swap-out with the decoding operation.

7. The method of claim 1, wherein the switching of the contexts comprises performing the swap-out for partial blocks of the request to be swapped out, based on a defined condition.

8. The method of claim 1, wherein the switching of the contexts comprises maintaining a swapped-out block in central processing unit (CPU) memory based on swapping a swapped-out request into graphics processing unit (GPU) memory.

9. The method of claim 1, wherein the swap cost-aware scheduling algorithm comprises performing only swap-in of the request to be swapped in, when a number of the second blocks is greater than or equal to the number of the first blocks.

10. The method of claim 1, wherein the performing of the swap cost-aware scheduling algorithm comprises performing a partial prefill operation that processes a portion of a pending request beforehand, based on a number of remaining available blocks.

11. A server for handling multiple user requests for a large language model (LLM), the server comprising:
at least one accelerator;
at least one processor;
a communication interface; and
memory storing instructions,
wherein the instructions, when executed by the at least one processor, cause the server to:
receive a plurality of requests through the communication interface,
generate a response to each of the plurality of requests by handling the plurality of requests by performing swap cost-aware scheduling,
wherein the instructions, when executed by the at least one processor, cause the server to generate the response to each of the plurality of requests by generating tokens that constitute the response to each request through a decoding operation managed by a scheduler, and
wherein the instructions, when executed by the at least one processor, cause the server to perform the swap cost-aware scheduling by performing operations at each scheduling time stage, the operations comprising:
based on a swap-in cost of each of swapped requests, determining a request to be swapped in;
determining a number of first blocks corresponding to requests being executed and the request to be swapped in;
determining a swap-out cost of each of the requests being executed when a number of second blocks is less than the number of the first blocks, wherein the second blocks are available blocks;
determining a request to be swapped out from among the requests being executed, based on the swap-out cost;
switching contexts by performing swap-in and swap-out; and
generating the tokens that constitute the response to each request through the decoding operation.

12. The server of claim 11, wherein the instructions, when executed by the at least one processor, cause the server to determine the swap-out cost of each of the requests being executed, based on at least one of transmission latency caused by swap-out of a respective request, throughput reduction caused by swap-out of the respective request, or future memory pressure caused by the respective request.

13. The server of claim 12, wherein the instructions, when executed by the at least one processor, cause the server to dynamically adjust weights to be applied to a cost of the transmission latency, a cost of the throughput reduction and a cost of the future memory pressure, based on at least one of a service level objective (SLO) for latency, a load condition of the server or a memory usage state.

14. The server of claim 11, wherein the instructions, when executed by the at least one processor, cause the server to:
determine a swap-in transmission time for each of the swapped requests,
determine the swap-in cost of each of the swapped requests, based on at least one of the swap-in transmission time, a swap elapsed time of the request, a remaining processing time, or the SLO for latency; and
determine the request to be swapped in from among the swapped requests, based on the swap-in cost.

15. The server of claim 11, wherein the instructions, when executed by the at least one processor, cause the server to:
determine a number of third blocks occupied by the request to be swapped out, and
reduce an amount of the swap-in when the number of the third blocks occupied by the request to be swapped out is less than the number of the first blocks.

16. The server of claim 11, wherein the instructions, when executed by the at least one processor, cause the server to asynchronously perform the swap-in and the swap-out by interleaving the swap-in and the swap-out with the decoding operation.

17. The server of claim 11, wherein the instructions, when executed by the at least one processor, cause the server to perform the swap-out for partial blocks of the request to be swapped out, based on a defined condition.

18. The server of claim 11, wherein the instructions, when executed by the at least one processor, cause the server to maintain a swapped-out block in central processing unit (CPU) memory based on swapping a swapped-out request into graphics processing unit (GPU) memory.

19. The server of claim 11, wherein the instructions, when executed by the at least one processor, cause the server to perform a partial prefill operation that processes a portion of a pending request beforehand, based on a number of remaining available blocks.

20. A non-transitory computer-readable storage media storing one or more computer programs including computer-executable instructions that, when executed by at least one processor of a server, cause the server to perform operations, the operations comprising:
receiving a plurality of requests; and
generating a response to each of the plurality of requests by handling the plurality of requests by performing swap cost-aware scheduling,
wherein the generating of the response to each of the plurality of requests comprises generating tokens that constitute the response to each of the plurality of requests through a decoding operation managed by a scheduler, and
wherein the performing of the swap cost-aware scheduling comprises performing operations at each scheduling time stage, the operations comprising:
based on a swap-in cost of each of swapped requests, determining a request to be swapped in;
determining a number of first blocks corresponding to requests being executed and the request to be swapped in;
determining a swap-out cost of each of the requests being executed when a number of second blocks is less than the number of the first blocks, wherein the second blocks are available blocks;
determining a request to be swapped out from among the requests being executed, based on the swap-out cost;
switching contexts by performing swap-in and swap-out; and
generating the tokens that constitute the response to each request through the decoding operation.
